(19) United States
(12) Patent Application Publication
(10) Pub. No.: US 2025/0089036 A1
(43) Pub. Date: Mar. 13, 2025

(54) METHOD AND APPARATUS OF BEAM DETERMINATION

(71) Applicant: LENOVO (BEIJING) LIMITED, Beijing (CN)

(72) Inventors: Wei Ling, Beijing (CN); Yi Zhang, Beijing (CN); Chenxi Zhu, Fairfax, VA (US); Bingchao Liu, Beijing (CN); Lingling Xiao, Beijing (CN)

(21) Appl. No.: 18/726,688

(22) PCT Filed: Jan. 7, 2022
(86) PCT No.: PCT/CN2022/070668

§ 371 Date: Jul. 3, 2024

(51) Int. Cl. H04W 72/044; H04L 5/00; H04W 72/21

(52) U.S. Cl. CPC H04W 72/046; H04L 5/0091; H04W 72/21

(57) ABSTRACT

Embodiments of the present application are related to a method and apparatus for beam determination. An exemplary method of the present application includes: receiving information indicating a set of joint or uplink common transmission configuration indication (TCI) state; and for a user equipment (UE) capable of transmitting an link transmission according to more than one TCI state simultaneously in a time interval where the set of joint or uplink common TCI state is applicable, transmitting the uplink transmission according to: a) the set of joint or uplink common TCI state simultaneously, or b) the set of joint or uplink common TCI state simultaneously and a beam indication associated with the uplink transmission.

### TECHNICAL FIELD

Embodiments of the present application are related to wireless communication technology, especially, related to a method and apparatus of beam determination.

### BACKGROUND OF THE INVENTION

Regarding enhancements on multiple-input multiple-output (MIMO) for new radio (NR), a work item description (WID) approved in NR release (R)17 includes enhancement on multi-beam operation, mainly targeting frequency range (FR)2 while also applicable to FR1. Wherein, a research topic is to identify and specify features to facilitate more efficient (lower latency and overhead) downlink/uplink (DL/UL) beam management to support higher intra-band and L1/L2-centric inter-cell mobility and/or a larger number of configured transmission configuration indication (TCI) states, including common beam for data and control transmission/reception for DL and UL, especially for intra-band carrier aggregation (CA).

In R17, only one joint or UL common beam is indicated for UL transmission. Thus, only one joint or UL common beam is used for physical uplink shared channel (PUSCH) transmission and physical uplink control channel (PUCCH) transmission. Although more than one common beam in a scenario of multiple transmit-receive points (TRPs) or multiple panels will not be discussed in R17, it may be further studied in R18 which has been discussed in R18 workshop. Then, more than one joint or UL common beam may be indicated for the scenario of multiple TRPs (or multiple panels) in R18, and multiple panels UL simultaneous transmission will be discussed. Thus, it is possible to dynamically switch between one common beam and multiple common beams for UL transmission.

Therefore, the industry desires a technical solution to support such dynamic switch between one common beam and multiple common beams for UL transmission.

### SUMMARY

One objective of the embodiments of the present application is to provide a technical solution of beam determination, especially related to beam determination for uplink transmission considering dynamic switch between one common beam and multiple common beams.

Some embodiments of the present application provide an exemplary method, which includes: receiving information indicating a set of joint or uplink common TCI state; and for a user equipment (UE) capable of transmitting an link transmission according to more than one TCI state simultaneously in a time interval where the set of joint or uplink common TCI state is applicable, transmitting the uplink transmission according to: a) the set of joint or uplink common TCI state simultaneously, or b) the set of joint or uplink common TCI state simultaneously and a beam indication associated with the uplink transmission.

In some embodiments of the present application, the uplink transmission is a frequency divisional multiplexing (FDM) uplink transmission, and is transmitted according to the set of joint or uplink common TCI state simultaneously. In the case that there are two joint or uplink common TCI states in the set of joint or uplink common TCI state, a first occasion with lower starting frequency resource block of the uplink transmission is transmitted according to a first one of the two joint or uplink common TCI states, and a second occasion with higher starting frequency resource block of the uplink transmission is transmitted according to a second one of the two joint or uplink common TCI states.

In some embodiments of the present application, the uplink transmission is a single frequency network (SFN) uplink transmission or a spatial divisional multiplexing (SDM) PUSCH transmission, and is transmitted according to the set of joint or uplink common TCI state simultaneously.

In some embodiments of the present application, the uplink transmission is an SFN uplink transmission or an SDM PUSCH transmission, and is transmitted according to the set of joint or uplink common TCI state simultaneously and the beam indication associated with the uplink transmission.

For example, there are two joint or uplink common TCI states in the set of joint or uplink common TCI state, and in the case of the uplink transmission being an SFN uplink transmission, the beam indication indicates a second state of two states defined for the beam indication as the following: a first state that a first joint or uplink common TCI state of the two joint or uplink common TCI states is to be used for uplink transmission; or a second state that both of the two joint or uplink common TCI states are to be used for uplink transmission simultaneously.

In another example, there are two joint or uplink common TCI states in the set of joint or uplink common TCI state, and in the case of the uplink transmission being an SFN uplink transmission, the beam indication indicates a third state of three states defined for the beam indication as the following: a first state that a first joint or uplink common TCI state of the two joint or uplink common TCI states is to be used for uplink transmission; a second state that a second joint or uplink common TCI state of the two joint or uplink common TCI states is to be used for uplink transmission; or a third state that both of the two joint or uplink common TCI states are to be used for uplink transmission simultaneously.

In yet another example, there are two joint or uplink common TCI states in the set of joint or uplink common TCI state, and in the case of the uplink transmission being SDM PUSCH, the beam indication indicates a fourth state of four states defined for the beam indication as the following: a first state that a first joint or uplink common TCI state of the two joint or uplink common TCI states is to be used for uplink transmission; a second state that a second joint or uplink common TCI state of the two joint or uplink common TCI states is to be used for uplink transmission; or a third state that both of the two joint or uplink common TCI states are to be used for uplink transmission with repetition in time divisional multiplexing (TDM) manner, wherein each repetition of the uplink transmission is transmitted according to a corresponding joint or uplink common TCI state of the two joint or uplink common TCI states based on a mapping pattern and a first repetition of the uplink transmission is according to a first joint or uplink common TCI state of the two joint or uplink common TCI states; or a fourth state that both of the set of joint or uplink common TCI state are to be used for uplink transmission simultaneously.

In some embodiments of the present application, the beam indication is: in a field of a scheduling DCI of the uplink transmission, in the case that the uplink transmission is a dynamic grant (DG) PUSCH transmission; or in a field of an activating DCI of the uplink transmission, in the case that the uplink transmission is a configured grant (CG) Type2 PUSCH transmission; or in a field of radio resource control (RRC) configuration of the uplink transmission in the case that uplink transmission is CG Type1 PUSCH transmission; or in a field configured by RRC or indicated by media access control (MAC) control element (CE) in the case that uplink transmission is PUCCH transmission.

In some embodiments of the present application, in the case that there is only one joint or uplink common TCI state in the set of joint or uplink common TCI state, the uplink transmission is transmitted according to the one joint or uplink common TCI state.

Some embodiments of the present application provide another exemplary method, which includes: transmitting information indicating a set of joint or uplink common TCI state; and from a UE capable of transmitting an uplink transmission according to more than one TCI state simultaneously in a time interval where the set of joint or uplink common TCI state is applicable, receiving the uplink transmission according to: a) the set of joint or uplink common TCI state simultaneously, or b) the set of joint or uplink common TCI state and a beam indication associated with the uplink transmission.

Some embodiments of the present application provide an exemplary apparatus, e.g., a UE, which includes: at least one receiving circuitry; at least one transmitting circuitry; and at least one processor coupled to the at least one receiving circuitry and the at least one transmitting circuitry, wherein the at least one processor is configured to: receive information indicating a set of joint or uplink common TCI state; and in the case of the UE being capable of transmitting an uplink transmission according to more than one TCI state simultaneously in a time interval where the set of joint or uplink common TCI state is applicable, transmit the uplink transmission according to: a) the set of joint or uplink common TCI state simultaneously, or b) the set of joint or uplink common TCI state and a beam indication associated with the uplink transmission.

Embodiments of the present application can solve the beam determination for uplink transmission when multiple (e.g., two) joint or uplink common beams are applicable in a time interval, and thus will facilitate the deployment and implementation of the NR.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2 illustrates a flow chart of a method of beam determination according to some embodiments of the present application.

FIG. 3 illustrates a schematic diagram of beam determination for uplink transmission under FDM scheme according to some embodiments of the present application.

FIG. 4 illustrates a schematic diagram of beam determination for uplink transmission under SDM scheme according to some embodiments of the present application.

FIG. 5 illustrates a simplified block diagram of an apparatus of beam determination according to some embodiments of the present application.

FIG. 6 illustrates a simplified block diagram of an apparatus of beam determination according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems; and moreover, the terminologies recited in the present application may change, which should not affect the principle of the present application.

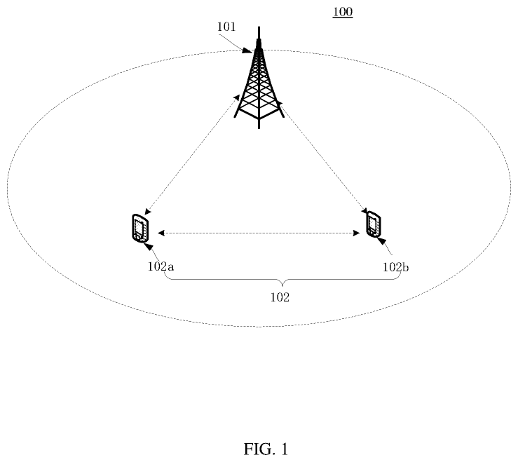

FIG. 1 illustrates a schematic diagram of an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In R17, common beam for data and control transmission/reception for DL and UL, especially for intra-band CA is introduced to improve latency and efficiency with more usage of dynamic control signaling. The terminology “beam” can be represented by or associated with spatial relation information, TCI state, reference signal (RS) etc. For example, a beam for physical downlink control channel (PDSCH) can be illustrated as: a TCI state wherein demodulation-reference signal (DM-RS) antenna ports of the PDSCH are quasi co-located with a set of RSs in a TCI state with respect to a set of quasi co-located (QCL) parameters; and a beam for PUSCH can be illustrated as: a spatial transmit filter of the PUSCH which is according to a RS configured with QCL-Type D of a TCI state.

Regarding downlink transmission, according to R16, two TCI states have been applied for PDSCH Scheme 1 which is a non-coherent joint transmission (NCJT) transmission by two TRPs. NCJT transmission may also be referred to as SDM transmission. Besides, two TCI states have been applied for a PDSCH in the SFN scheme (or mode) in R17. However, regarding uplink transmission, multiple beams can be used for uplink transmission only in the TDM manner. Taking DG PUSCH as an example, a two-bit field in the scheduling DCI indicates which beam(s) will be used for each repetition of the PUSCH transmission.

It was discussed in R18 workshop that simultaneous transmission of multiple panels (or multiple TRPs) will be supported for uplink transmission, and multiple joint or uplink common TCI states can be indicated for multiple panels. Thus, SFN, FDM and SDM transmission may also be possible for uplink transmission in R18 due to simultaneous multi-panel uplink transmission. Meanwhile, for some UEs, they may be capable of supporting dynamic switch between one beam and multiple beams for UL transmissions. For some UEs, it is also possible to support dynamic switch between different uplink transmission schemes (or types or configurations etc.), e.g., between TDM uplink transmission and SDM uplink transmission.

In view of the above, beam determination should be further studied and solved for uplink transmission. At least considering that, embodiments of the present application provide a technical solution of beam determination, especially for beam determination of uplink transmission when there are two or more joint or uplink common beams are applicable in a time interval, e.g., in at least one slot.

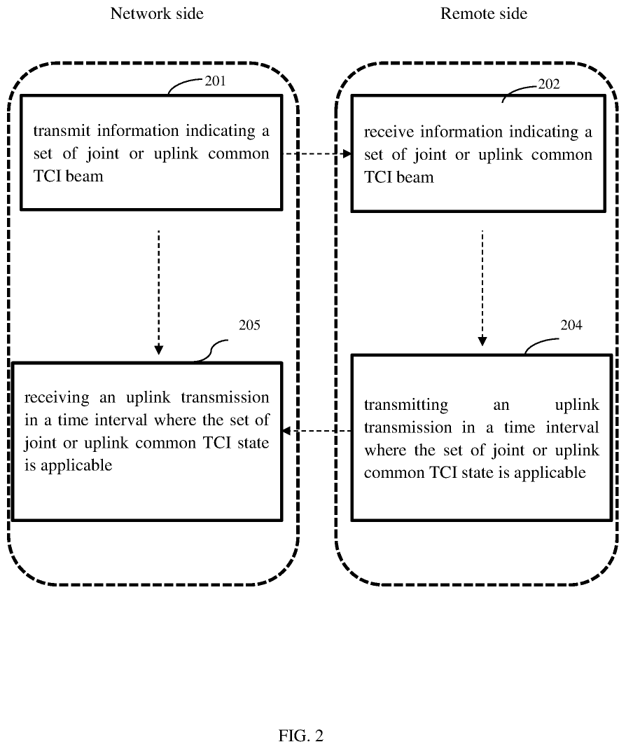

FIG. 2 illustrates a flow chart of a method of beam determination according to some embodiments of the present application. Although the method is illustrated in a system level by an apparatus, e.g., a UE in a remote side (or a UE side) and an apparatus, e.g., a radio access network (RAN) node in a network side (or a BS side), persons skilled in the art should understand that the method implemented in the remote side and that implemented in the network side can be separately implemented and incorporated by other apparatus with the like functions.

As shown in FIG. 2, in step 201, the network side, e.g., the BS 101 as shown in FIG. 1 will transmit information indicating a set of joint or uplink common TCI beam to the remote side. Herein, the wording “a set of” means “at least one” or “one or more” or the like. The set of joint or uplink common beam may be indicated by a DCI, i.e., downlink control information in a physical downlink control channel (PDCCH) where the set of joint or uplink common beam is one TCI codepoint of multiple TCI codepoints activated by a MAC CE, or directly indicated by a MAC CE when only one TCI codepoint is activated by the MAC CE. For example, the set of joint or uplink common beam may be one or more joint or uplink common beams represented by one or more joint or uplink common TCI states indicated by a TCI codepoint indicated by a TCI field of a DCI. Herein, a joint or uplink common beam for uplink can be represented by a joint or uplink common TCI state.

Accordingly, the remote side, e.g., the UE 102 as shown in FIG. 1 will receive the information indicating a set of joint or uplink common beam in step 202. When the common beam(s) is indicated by a DCI, it is applicable or valid starting from applicable time. According to some embodiments of the present application, the applicable time is the first slot that is at least a number of symbols configured by a RRC signaling according to UE capability after the acknowledgement (ACK) of the DCI for indicating the common beam(s). Similarly, when the common beam(s) is indicated by a MAC CE, it is applicable or valid starting from applicable time. According to some embodiments of the present application, the applicable time is the first slot that is at least 3 millisecond after the HARQ-ACK of a PDSCH carrying the MAC CE.

For example, according to the agreement in RAN1 #104b-e, regarding the application time of the beam indication which is indicated by a DCI, the first slot to apply the indicated TCI state is at least Y symbols after the last symbol of the acknowledgment of the common beam indication, e.g., joint or uplink common beam indication. The Y symbols are configured by the gNB based on UE capability via a RRC signaling, which is also reported in units of symbols. For another example, in RAN1 #107-e, on Rel-17 DCI-based beam indication, regarding the application time of the beam indication, the UE can assume that one beam application time (BAT) for a given SCS is configured for all the CCs configured with the common TCI state ID update.

When the set of joint or uplink common beam are applicable in a time interval, e.g., in at least one slot and the UE is capable of transmitting an uplink transmission according to more than one TCI state simultaneously, in step 204, the UE may transmit the uplink transmission according to the set of joint or uplink common TCI state simultaneously in some embodiments of the present application, or may transmit the uplink transmission according to the set of joint or uplink common TCI state and a beam indication associated with the uplink transmission in some other embodiments of the present application. Accordingly, the network side, e.g., the BS 101 as shown in FIG. 1 may receive the uplink transmission accordingly in step 205, e.g., according to the set of joint or uplink common TCI state simultaneously or according to the set of joint or uplink common TCI state and a beam indication associated with the uplink transmission. However, in the case that there is only one joint or uplink common TCI state in the set of joint or uplink common TCI state, the uplink transmission is transmitted according to the one joint or uplink common TCI state.

The uplink transmission to be transmitted according to more than one TCI state simultaneously can be configured in various manners, e.g., in FDM scheme, SFN scheme, or SDM (or NCJT) scheme. Dependent on the UE's capability, it may support partial or all these schemes. In addition, some UE may also support dynamic switch between a single beam for uplink transmission (single-TRP uplink transmission) and multiple beams for uplink transmission (multi-TRP uplink transmission). For example, some UE may support dynamic switch between single-TRP uplink transmission and SFN uplink transmission, or dynamic switch between single-TRP uplink transmission and SDM uplink transmission etc. According to some embodiments of the present application, when UE supports such a dynamic switch, a beam indication will be configured or indicated by the network side. The beam indication has a plurality of states, each state indicating which joint or uplink common beam(s) will be used for uplink transmission. For an uplink transmission to be transmitted according to more than one TCI state simultaneously, it can only be transmitted when the beam indication indicates a state corresponding to such an uplink transmission. However, if a UE does not support such a dynamic switch but is capable of transmitting an uplink transmission according to more than one TCI state simultaneously under a specific scheme, e.g., FDM scheme, or SFN scheme, or SDM scheme, the UE will transmit the uplink transmission according to more than one TCI state simultaneously without the additional beam indication.

The beam indication can be included in a field. For example, for a DG PUSCH transmission, the beam indication can be in a field of a scheduling DCI of the DG PUSCH transmission. For a CG Type2 PUSCH transmission, the beam indication can be in a field of an activating DCI, e.g., DCI format 0_1 or DCI format 0_2 of the CG Type2 PUSCH transmission. For a CG Type1 PUSCH transmission, the beam indication can be in a field of RRC configuration of a CG Type1 PUSCH transmission. For a PUCCH transmission, the beam indication can be in a field configured by RRC or indicated by MAC CE for the PUCCH transmission.

Hereafter, several exemplary uplink transmission schemes are illustrated in details according to some embodiments of the present application, which is under the premise that for a time interval wherein the uplink transmission is to be transmitted or received, all the indicated joint or uplink common beams are applicable. In addition, embodiments of the present application are illustrated concerning on two joint or uplink common beams, e.g., two joint or uplink common TCI states indicated by a TCI codepoint in a TCI field of a DCI. However, persons skilled in the art should well know that the illustrated technical solution would also be applied to similar scenarios with more than two joint or uplink common beams. Moreover, considering the consistency between the network side and the UE side, although some details are provided concerning on only one side, e.g., the UE side, persons skilled in the art should well know how to apply these in the other side.

### FDM Uplink Transmission (FDM Scheme)

According to some embodiments of the present application, when the uplink transmission is an FDM uplink transmission (that is, FDM scheme is configured for uplink transmission), it can be transmitted by the UE according to the set of joint or uplink common TCI state simultaneously, and accordingly will be received in the network side according to the set of joint or uplink common TCI state simultaneously. For example, in the case that there are two joint or uplink common TCI states in the set of joint or uplink common TCI state, the first occasion with lower starting frequency resource block of the FDM uplink transmission is transmitted according to a first one of the two joint or uplink common TCI states, and the second occasion with higher starting frequency resource block of the FDM uplink transmission is transmitted according to a second one of the two joint or uplink common TCI states.

In addition, when FDM scheme is configured for uplink transmission, it may be configured jointly for PUSCH (or PUSCH transmission) and PUCCH (or PUCCH transmission), or it may be configured separately for PUSCH and PUCCH. Therefore, although exemplary embodiments are illustrated in view of beam determination only for PUSCH in the following, persons skilled in the art should well know how to apply such solutions to PUCCH.

In some embodiments of the present application, for an FDM PUSCH transmission in a time interval, e.g., from slot n to at least slot (n+k), k>=0, if two joint or uplink common TCI states are applicable in the time interval, the transmission occasion with lower starting frequency resource block of the FDM PUSCH transmission is transmitted according to the first one of the two joint or uplink common TCI states, and the transmission occasion with higher starting frequency resource block of the FDM PUSCH transmission is transmitted according to the second one of two joint or uplink common TCI states.

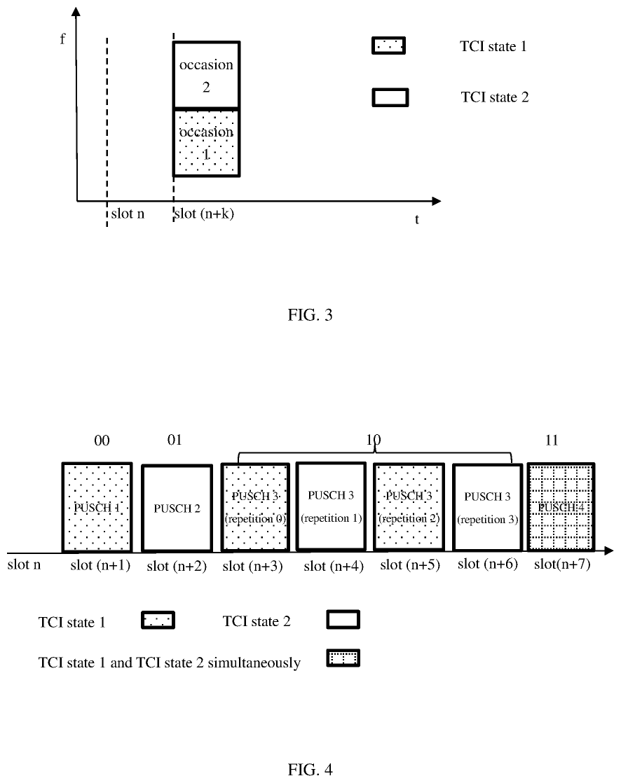

FIG. 3 illustrates a schematic diagram of beam determination for uplink transmission under FDM scheme according to some embodiments of the present application.

Referring to FIG. 3, FDM scheme is configured for PUSCH. A TCI field in a DCI codepoints 2 joint or uplink common TCI states, e.g., TCI state 1 and TCI state 2, wherein the first joint or uplink common TCI state indicated in the TCI field is TCI state 1 and the second joint or uplink common TCI state indicated in the TCI field is TCI state 2. It is supposed that the two joint or uplink common TCI states are applicable from slot n, and an FDM PUSCH is to be transmitted in slot (n+k) (k>=0). Then, according to some embodiments of the present application, the first occasion which has lower starting resource block of the PUSCH, e.g., occasion 1 will be transmitted according to TCI state 1, and the second occasion which has higher starting resource block of the PUSCH, e.g., occasion 2 will be transmitted according to TCI state 2. The first occasion and the second occasion will be transmitted according to TCI state 1 and TCI state 2 simultaneously in slot (n+k).

### SFN Uplink Transmission (SFN Scheme)

When SFN scheme is configured for UL transmission, it means that UE will transmit each layer of an uplink transmission with different beams in the same time-frequency resource(s) twice. However, as 3GPP evolves, SFN scheme for UL transmission may also evolves, and each layer of an uplink transmission may be transmitted with different beams in the same time-frequency resource(s) more than twice.

Similar to FDM scheme, when SFN scheme is configured for uplink transmission, it may be configured jointly for PUSCH (or PUSCH transmission) and PUCCH (or PUCCH transmission), or it may be configured separately for PUSCH and PUCCH. Therefore, although some exemplary embodiments are illustrated in view of beam determination for PUSCH in the following, persons skilled in the art should well know how to apply such solutions to PUCCH.

Dependent on whether dynamic switch between one beam for uplink transmission and multiple beams for uplink transmission is supported, some embodiments of the present application provide two solutions for uplink transmission under SFN scheme, wherein the first one is dynamic switch between one beam for uplink transmission and multiple beams for uplink transmission is not supported, and the second one is dynamic switch between one beam for uplink transmission and multiple beams for uplink transmission is supported. In the case that the two solutions are both supported, UE can use the first solution or the second solution depending on its capability.

According to some embodiments of the present application, when the first solution is applied, the SFN uplink transmission, e.g., SFN PUSCH is always transmitted by the UE according to the set of joint or uplink common TCI state simultaneously, and received in the network side according to the set of joint or uplink common TCI state simultaneously. That is, there is no dynamic switch between single-TRP uplink transmission and SFN uplink transmission. For example, when the set of joint or uplink common TCI state are two joint or uplink common TCI states, the UE will transmit the SFN transmission according to the two joint or uplink common TCI state simultaneously, and the network side will receive the SFN transmission according to the two joint or uplink common TCI state simultaneously.

According to some other embodiments of the present application, when the second solution is applied, the SFN uplink transmission, e.g., SFN PUCCH is transmitted by the UE according to the set of joint or uplink common TCI state simultaneously and a beam indication associated with the SFN PUCCH transmission, and received in the network side according to the set of joint or uplink common TCI state simultaneously and the beam indication. That is, there is dynamic switch between single-TRP uplink transmission and SFN uplink transmission. Only if there is a corresponding beam indication. SFN uplink transmission will be transmitted by the UE and received in the network side.

In some embodiments of the present application, when the set of joint or uplink common TCI state are two joint or uplink common TCI states, two states may be defined for the beam indication, wherein the first state is that the first joint or uplink common TCI state of the two joint or uplink common TCI states is to be used for uplink transmission (i.e., single-TRP uplink transmission with the first common beam); and the second state is that both of the two joint or uplink common TCI states are to be used for uplink transmission simultaneously (i.e., SFN uplink transmission with the both two joint or uplink common beams). Herein (through the specification), the first state and the second state or the like are only used for distinguishing two or more different states of the beam indication, and should not be deemed as the substantial limitation to the states. When the UE receives the beam indication indicating the first state, it will transmit the uplink transmission according to the first joint or uplink TCI state, i.e., transmitting a single-TRP transmission with the first joint or uplink common beam. When the UE receives the beam indication indicating the second state, it will transmit SFN transmission according to the two joint or uplink common TCI states simultaneously.

As stated above, the beam indication can be included in a field. In some embodiments of the present application, the field may be 1 bit for the beam indication with 2 states. An exemplary field is illustrated in Table 1 in view of PUSCH transmission as follows.

TABLE 1

| A field to support dynamic switch between | |
|---|---|
| single-TRP PUSCH and SFN PUSCH | Beam(s) of PUSCH |
| 0 | The first joint or uplink common TCI state of two |
| | joint or uplink common TCI states |
| 1 | Two joint or uplink common TCI states |
| | simultaneously |

Persons skilled in the art should understand that the exemplary field in Table 1 is only for illustrating the principle of the corresponding field configuration. The specific information indicated by each exemplary state can be changed. For example, the first state set as “O” may indicate that both the two joint or uplink common TCI states, i.e., the first and second joint or uplink common TCI states are used for SFN transmissions simultaneously, while the second state set as “1” may indicate that the first one of the two joint or uplink common TCI states is used for single-TRP transmissions. In addition, the first state may indicate that the second one, rather than the first one of the two joint or uplink common TCI states, is used for single-TRP transmissions.

In some other embodiments of the present application, when the set of joint or uplink common TCI state are two joint or uplink common TCI states, three states may be defined for the beam indication, wherein a first state is that a first joint or uplink common TCI state of the two joint or uplink common TCI states is to be used for uplink transmission (i.e., single-TRP transmission with the first joint or uplink common beam); a second state is that a second joint or uplink common TCI state of the two joint or uplink common TCI states is to be used for uplink transmission (i.e., single-TRP transmission with the second joint or uplink common beam); and a third state is that both of the two joint or uplink common TCI states are to be used for uplink transmission simultaneously (i.e., SFN transmission with the both two joint or uplink common beam simultaneously). When the UE receives the beam indication indicating the first state, it will transmit the uplink transmission with the first joint or uplink common beam. When the UE receives the second state, it will transmit the uplink transmission with the second joint or uplink common beam. When the UE receives the beam indication indicating the third state, it will transmit the SFN transmission with the first and second joint or uplink common beam simultaneously.

An exemplary field may be 2 bits for a beam indication with 3 states, which is illustrated in Table 2 in view of PUSCH transmission as follows.

TABLE 2

| A field to support dynamic switch between | |
|---|---|
| single-TRP PUSCH and SFN PUSCH | Beam(s) of PUSCH |
| 00 | The first joint or uplink common TCI state of |
| | two joint or uplink common TCI states |
| 01 | The second joint or uplink common TCI state of |
| | two joint or uplink common TCI states |
| 10 | Two joint or uplink common TCI states |
| | simultaneously |
| 11 | Reserved |

Similarly, persons skilled in the art should understand that the exemplary field in Table 2 is only for illustrating the principle of the corresponding field configuration. The specific information indicated by each exemplary state can be changed. For example, the first state set as “00” may indicate that both the two joint or uplink common TCI states, i.e., the first and second joint or uplink common TCI states are used for SFN transmissions simultaneously, the second state set as “01” may indicate that the first one of the two joint or uplink common TCI states is used for single-TRP transmissions, and the third state set “10” may indicate that the second one of the two joint or uplink common TCI states is used for single-TRP transmissions. In addition, the above three states only include the three valid states and do not consider the reserved state “11.”

In addition, more bits than 2 bits may be used for the field based on similar configuration, e.g., the first state is set as “000” etc., which should also be within the scope of the embodiments of the present application.

### SDM (or NCJT) Uplink Transmission (SDM Scheme or NCJT Scheme)

When SDM scheme (or NCJT scheme) is configured or indicated by a DCI, it means that different uplink layers of the same UL transmission will be transmitted with different beams. For uplink transmission, considering that PUCCH transmission is a single port transmission, SDM scheme can only be configured or indicated for PUSCH transmission.

Similar to SFN scheme, dependent on whether dynamic switch between one beam and multiple beams for uplink transmission is supported, there may be two solutions for determining the beam(s) for PUSCH transmission under SDM scheme. The first one is dynamic switch between one beam and multiple beams for uplink transmission is not supported, and the second one is dynamic switch between one beam and multiple beams for uplink transmission is supported. In the case that the two solutions are both supported, UE can use the first solution or the second solution depending on its capability.

According to some embodiments of the present application, when the first solution is applied, the SDM uplink transmission is transmitted by the UE according to the set of joint or uplink common TCI state simultaneously, and received in the network side according to the set of joint or uplink common TCI state simultaneously. That is, there is no dynamic switch between single-TRP uplink transmission and SDM uplink transmission. For example, when the set of joint or uplink common TCI state are two joint or uplink common TCI states, the UE will transmit the SDM transmission according to the two joint or uplink common TCI state simultaneously, and the network side will receive the SDM transmission according to the two joint or uplink common TCI state simultaneously.

According to some other embodiments of the present application, when the second solution is applied, the SDM uplink transmission is transmitted by the UE according to the set of joint or uplink common TCI state simultaneously and a beam indication associated with the SDM uplink transmission, and received in the network side according to the set of joint or uplink common TCI state simultaneously and the beam indication. That is, there is dynamic switch between single-TRP uplink transmission and SDM uplink transmission. Only if there is a corresponding beam indication, SDM uplink transmission will be transmitted by the UE and received in the network side.

In some embodiments of the present application, when the set of joint or uplink common TCI state are two joint or uplink common TCI states, four states may be defined for the beam indication, wherein the first state is that the first joint or uplink common TCI state of the two joint or uplink common TCI states is to be used for uplink transmission (i.e., single-TRP uplink transmission with the first common beam); the second state is that the first joint or uplink common TCI state of the two joint or uplink common TCI states is to be used for uplink transmission (i.e., single-TRP uplink transmission with the first common beam); the third state is that both of the two joint or uplink common TCI states are to be used for uplink transmission with repetition in TDM manner (i.e., TDM uplink transmission with repetitions, wherein the repetition number is larger than one); and the fourth state is that both of the two joint or uplink common TCI states are to be used for uplink transmission simultaneously (i.e., SDM uplink transmission with the both two joint or uplink common beams). Moreover, in the third state, each repetition of the uplink transmission is transmitted according to a corresponding joint or uplink common TCI state of the two joint or uplink common TCI states based on a mapping pattern, and the first repetition of the uplink transmission is according to a beam, e.g., the first joint or uplink common TCI state of the two joint or uplink common TCI states. Thus, for the third state, a beam pattern will also be indicated to the UE, which may be a cyclical mapping pattern or a sequential mapping pattern as agreed by 3GPP.

When the UE receives the beam indication indicating the first state, it will transmit the uplink transmission according to the first joint or uplink TCI state, i.e., transmitting a single-TRP transmission with the first joint or uplink common beam. When the UE receives the beam indication indicating the second state, it will transmit the uplink transmission according to the second joint or uplink TCI state, i.e., transmitting a single-TRP transmission with the second joint or uplink common beam. When the UE receives the beam indication indicating the third state, it will transmit the uplink transmission according to the two joint or uplink common TCI states and a beam pattern in TDM manner. When the UE receives the beam indication indicating the fourth state, it will transmit SDM transmission according to the two joint or uplink common TCI states simultaneously.

An exemplary field may be 2 bits for the beam indication with 4 states, which is illustrated in Table 3 in view of PUSCH transmission as follows.

TABLE 3

| A field to support dynamic switch among | |
|---|---|
| single-TRP PUSCH, TDM PUSCH and SDM PUSCH | Beam(s) of PUSCH |
| 00 | The first joint or uplink common TCI state of two |
| | joint or uplink common TCI states |
| 01 | The second joint or uplink common TCI state of |
| | two joint or uplink common TCI states |
| 10 | TDM PUSCH transmission with repetitions, |
| | wherein, each repetition of PUSCH is transmitted |
| | according to one joint or uplink common TCI |
| | state of two joint or uplink common TCI states |
| | according to a beam mapping pattern |
| 11 | Two joint or uplink common TCI states for SDM |
| | PUSCH transmission |

Similarly, persons skilled in the art should understand that the exemplary field in Table 3 is only for illustrating the principle of the corresponding field configuration. The specific information indicated by each exemplary state can be changed. For example, the first state set as “00” may indicate that both the two common TCI states, i.e., the first and second common TCI states are used for SDM transmissions simultaneously, the second state set as “01” may indicate that indicate that both the two common TCI states, i.e., the first and second common TCI states are used for TDM transmission with repetitions; the third state set “10” may indicate that the first one of the two common TCI states is used for single-TRP transmissions, and the fourth state set “11” may indicate that the second one of the two common TCI states is used for single-TRP transmissions. In addition, more bits may be configured for this field in other embodiments.

In some other embodiments of the present application, the beam indication for SDM uplink transmission may be configured with only two states or only three state similar to SFN scheme. For example, only two states are configured considering switch between single-TRP uplink transmission with the first (or second) uplink or joint common beam and multi-TRP SDM uplink transmission is considered. Only three states are configured considering switch among single-TRP uplink transmission with the first uplink or joint common beam, single-TRP uplink transmission with the second uplink or joint common beam and multi-TRP SDM uplink transmission is considered, or considering switch among single-TRP uplink transmission with the first (or second) uplink or joint common beam, multi-TRP TDM uplink transmission and multi-TRP SDM uplink transmission is considered.

FIG. 4 illustrates a schematic diagram of beam determination for uplink transmission under SDM scheme according to some embodiments of the present application.

It is supposed that a UE supports dynamic switch among single-TRP PUSCH, TDM PUSCH and SDM PUSCH. Referring to FIG. 4, a TCI field in a DCI codepoints 2 joint or uplink common TCI states, e.g., TCI state 1 and TCI state 2, wherein the first indicated joint or uplink common TCI state is TCI state 1, and the second joint or uplink common indicated TCI state is TCI state 2. The two indicated joint or uplink common TCI states are applicable from slot n. In addition, PUSCH 1 is scheduled to be transmitted in slot (n+1) by a DCI 1, and the corresponding state of the beam indication indicated in the DCI is “00.” PUSCH 2 is scheduled to be transmitted in slot (n+2) by another DCI, and the corresponding state of the beam indication indicated in is “01.” PUSCH 3 is a CG Type 1 PUSCH with four repetitions, which is configured to be transmitted in slot (n+3), slot (n+4), slot (n+5) and slot (n+6) repeatedly, and the corresponding state of the beam indication in the RRC configuration is “10.” Moreover, a cyclical mapping pattern is configured for PUSCH 3. PUSCH 4 is scheduled to be transmitted in slot (n+7) by yet another DCI, and the corresponding state of the beam indication indicated in the DCI is “11.”

Accordingly, the UE will transmit PUSCH 1 according to TCI state 1 in slot (n+1), then transmit PUSCH 2 according to TCI state 2 in slot (n+2), transmit the first and third repetitions of PUSCH 3 respectively in slot (n+3) and slot (n+5) according to TCI state 1, transmit the second and fourth repetitions of PUSCH 3 in slot (n+4) and slot (n+6) according to TCI state 2, and then transmit PUSCH 4 according to TCI state 1 and TCI state 2 simultaneously in slot (n+7).

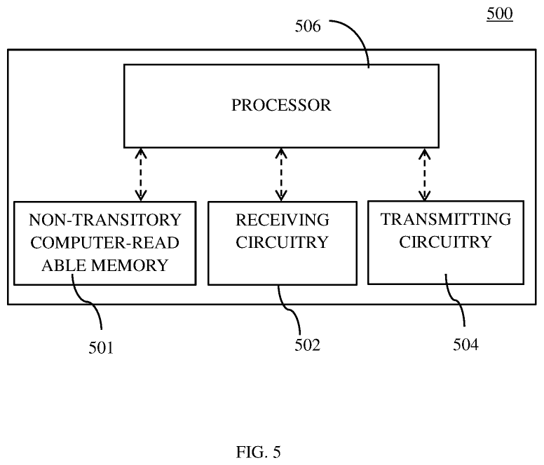

Besides methods, embodiments of the present application also propose an apparatus of beam determination. For example, FIG. 5 illustrates a block diagram of an apparatus 500 of beam determination according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The at least one processor 506 may be a CPU, a DSP, a microprocessor etc. The apparatus 500 may be a terminal device (e.g., a UE) configured to perform a method illustrated in the above or the like.

Although in this figure, elements such as the at least one processor 606, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

In some embodiments of the present application, the non-transitory computer-readable medium 501 may have stored thereon computer-executable instructions to cause a processor to implement the method with respect to the terminal device as described above. For example, the computer-executable instructions, when executed, cause the processor 506 interacting with receiving circuitry 502 and transmitting circuitry 504, so as to perform the steps with respect to the apparatus in the remote side, e.g., UE as depicted above.

In some embodiments of the present application, the non-transitory computer-readable medium 501 may have stored thereon computer-executable instructions to cause a processor to implement the method with respect to the CU or DU as described above. For example, the computer-executable instructions, when executed, cause the processor 506 interacting with receiving circuitry 502 and transmitting circuitry 504, so as to perform the steps with respect to the apparatus in the network side, e.g., a BS illustrated above.

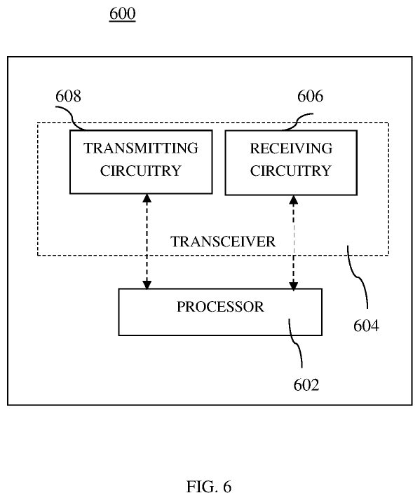

FIG. 6 illustrates a simplified block diagram of an apparatus of beam determination according to some other embodiments of the present application.

Referring to FIG. 6, the apparatus 600, for example a UE or a BS may include at least one processor 602 and at least one transceiver 604 coupled to the at least one processor 602. The at least one processor 602 may be a CPU, a DSP, a microprocessor etc. The transceiver 604 may include at least one separate receiving circuitry 606 and transmitting circuitry 608, or at least one integrated receiving circuitry 606 and transmitting circuitry 608.

According to some embodiments of the present application, when the apparatus 600 is a UE, the processor is configured to: receive information indicating a set of joint or uplink common TCI state; and for a UE capable of transmitting an link transmission according to more than one TCI state simultaneously in a time interval where the set of joint or uplink common TCI state is applicable, transmit the uplink transmission according to: a) the set of joint or uplink common TCI state simultaneously, or b) the set of joint or uplink common TCI state simultaneously and a beam indication associated with the uplink transmission.

According to some other embodiments of the present application, when the apparatus 600 is a BS, the processor may be configured to: transmit information indicating a set of joint or uplink common TCI state; and from a UE capable of transmitting an uplink transmission according to more than one TCI state simultaneously in a time interval where the set of joint or uplink common TCI state is applicable, receive the uplink transmission according to: a) the set of joint or uplink common TCI state simultaneously, or b) the set of joint or uplink common TCI state and a beam indication associated with the uplink transmission.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which is capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A method performed by a user equipment (UE), the method comprising:
receiving information indicating a set of joint or uplink common transmission configuration indication (TCI) state; and
for a UE capable of transmitting an uplink transmission according to more than one TCI state in a time interval where the set of joint or uplink common TCI state is applicable, transmitting the uplink transmission according to the set of joint or uplink common TCI state and a beam indication associated with the uplink transmission.

2. The method of claim 1, wherein, the uplink transmission is a frequency divisional multiplexing (FDM) uplink transmission, and is transmitted according to the set of joint or uplink common TCI state.

3. The method of claim 2, wherein,
in the case that there are two joint or uplink common TCI states in the set of joint or uplink common TCI state, a first occasion with lower starting frequency resource block of the uplink transmission is transmitted according to a first one of the two joint or uplink common TCI states, and a second occasion with higher starting frequency resource block of the uplink transmission is transmitted according to a second one of the two joint or uplink common TCI states.

4. The method of claim 1, wherein the uplink transmission is a single frequency network (SFN) uplink transmission or a spatial divisional multiplexing (SDM) physical uplink shared channel (PUSCH) transmission, and is transmitted according to the set of joint or uplink common TCI state.

5. The method of claim 1, wherein the uplink transmission is a single frequency network (SFN) uplink transmission or a spatial divisional multiplexing (SDM) physical uplink shared channel (PUSCH) transmission, and is transmitted according to the set of joint or uplink common TCI state and the beam indication associated with the uplink transmission.

6. The method of claim 5, wherein, there are two joint or uplink common TCI states in the set of joint or uplink common TCI state, and in the case of the uplink transmission being an SFN uplink transmission, the beam indication indicates a second state of two states defined for the beam indication as the following:
a first state that a first joint or uplink common TCI state of the two joint or uplink common TCI states is to be used for uplink transmission; or
a second state that both of the two joint or uplink common TCI states are to be used for uplink transmission simultaneously.

7. The method of claim 5, wherein, there are two joint or uplink common TCI states in the set of joint or uplink common TCI state, and in the case of the uplink transmission being an SFN uplink transmission or being a SDM PUSCH, the beam indication indicates a third state of three states defined for the beam indication as the following:
a first state that a first joint or uplink common TCI state of the two joint or uplink common TCI states is to be used for uplink transmission;
a second state that a second joint or uplink common TCI state of the two joint or uplink common TCI states is to be used for uplink transmission; or
a third state that both of the two joint or uplink common TCI states are to be used for uplink transmission.

8. The method of claim 5, wherein, there are two joint or uplink common TCI states in the set of joint or uplink common TCI state, and in the case of the uplink transmission being SDM PUSCH, the beam indication indicates a fourth state of four states defined for the beam indication as the following:
a first state that a first joint or uplink common TCI state of the two joint or uplink common TCI states is to be used for uplink transmission;
a second state that a second joint or uplink common TCI state of the two joint or uplink common TCI states is to be used for uplink transmission; or
a third state that both of the two joint or uplink common TCI states are to be used for uplink transmission with repetition in time divisional multiplexing (TDM) manner, wherein each repetition of the uplink transmission is transmitted according to a corresponding joint or uplink common TCI state of the two joint or uplink common TCI states based on a mapping pattern and a first repetition of the uplink transmission is according to a first joint or uplink common TCI state of the two joint or uplink common TCI states; or
a fourth state that both of the set of joint or uplink common TCI state are to be used for uplink transmission.

9. The method of claim 1, wherein, the beam indication is:
in a field of a scheduling downlink control information (DCI) of the uplink transmission, in the case that the uplink transmission is a dynamic grant (DG) physical uplink shared channel (PUSCH) transmission; or
in a field of an activating DCI of the uplink transmission, in the case that the uplink transmission is a configured grant (CG) Type2 PUSCH transmission; or
in a field of radio resource control (RRC) configuration of the uplink transmission in the case that uplink transmission is configured granted (CG) Type1 PUSCH transmission; or
in a field configured by RRC or indicated by media access control (MAC) control element (CE) in the case that uplink transmission is physical uplink control channel (PUCCH) transmission.

10. A method performed by a user equipment (UE), the method comprising:
transmitting information indicating a set of joint or uplink common transmission configuration indication (TCI) state; and
from a UE capable of transmitting an uplink transmission according to more than one TCI state in a time interval where the set of joint or uplink common TCI state is applicable, receiving the uplink transmission according to the set of joint or uplink common TCI state and a beam indication associated with the uplink transmission.

11. The method of claim 10, wherein, the uplink transmission is a frequency divisional multiplexing (FDM) uplink transmission, and is received according to the set of joint or uplink common TCI state.

12. The method of claim 11, wherein,
in the case that there are two joint or uplink common TCI states in the set of joint or uplink common TCI state, a first occasion with lower starting frequency resource block of the uplink transmission is received according to a first one of the two joint or uplink common TCI states, and a second occasion with higher starting frequency resource block of the uplink transmission is received according to a second one of the two joint or uplink common TCI states.

13. The method of claim 10, wherein the uplink transmission is a single frequency network (SFN) uplink transmission or a spatial divisional multiplexing (SDM) physical uplink shared channel (PUSCH) transmission, and is received according to the set of joint or uplink common TCI state.

14. The method of claim 10, wherein the uplink transmission is a single frequency network (SFN) uplink transmission or a spatial divisional multiplexing (SDM) physical uplink shared channel (PUSCH) transmission, and is received according to the set of joint or uplink common TCI state and the beam indication associated with the uplink transmission.

15. A user equipment (UE), comprising:
at least one memory; and
at least one processor coupled with the at least one memory and configured to cause the UE to:
receive information indicating a set of joint or uplink common transmission configuration indication (TCI) state; and
in the case of the UE being capable of transmitting an uplink transmission according to more than one TCI state in a time interval where the set of joint or uplink common TCI state is applicable, transmit the uplink transmission according to the set of joint or uplink common TCI state and a beam indication associated with the uplink transmission.

16. The UE of claim 15, wherein, the uplink transmission is a frequency divisional multiplexing (FDM) uplink transmission, and is transmitted according to the set of joint or uplink common TCI state.

17. The UE of claim 16, wherein,
in the case that there are two joint or uplink common TCI states in the set of joint or uplink common TCI state, a first occasion with lower starting frequency resource block of the uplink transmission is transmitted according to a first one of the two joint or uplink common TCI states, and a second occasion with higher starting frequency resource block of the uplink transmission is transmitted according to a second one of the two joint or uplink common TCI states.

18. The UE of claim 15, wherein the uplink transmission is a single frequency network (SFN) uplink transmission or a spatial divisional multiplexing (SDM) physical uplink shared channel (PUSCH) transmission, and is transmitted according to the set of joint or uplink common TCI state.

19. The UE of claim 15, wherein the uplink transmission is a single frequency network (SFN) uplink transmission or a spatial divisional multiplexing (SDM) physical uplink shared channel (PUSCH) transmission, and is transmitted according to the set of joint or uplink common TCI state and the beam indication associated with the uplink transmission.

20. A processor for wireless communication, comprising:
at least one controller coupled with at least one memory and configured to cause the processor to:
receive information indicating a set of joint or uplink common transmission configuration indication (TCI) state; and
in the case of the UE being capable of transmitting an uplink transmission according to more than one TCI state in a time interval where the set of joint or uplink common TCI state is applicable, transmit the uplink transmission according to the set of joint or uplink common TCI state and a beam indication associated with the uplink transmission.
